(19) United States
(12) Patent Application Publication
(10) Pub. No.: US 2025/0274146 A1
(43) Pub. Date: Aug. 28, 2025

(54) Wireless transmission module for an unmanned aerial vehicle

(71) Applicant: QISDA CORPORATION, Taoyuan City (TW)

(72) Inventors: Chih-Ming Chang, Taoyuan City (TW); Po-Fu Wu, Taoyuan City (TW)

(73) Assignee: QISDA CORPORATION, Taoyuan City (TW)

(21) Appl. No.: 19/019,503

(22) Filed: Jan. 14, 2025

(30) Foreign Application Priority Data
Feb. 27, 2024 (TW) 113106973

(51) Int. Cl. H04B 1/00

(52) U.S. Cl. CPC H04B 1/006; H04B 1/0003

(57) ABSTRACT

A wireless transmission module for an unmanned aerial vehicle (UAV) includes a processor, a baseband integrated circuit, and an antenna. The processor is used to process data to generate a UAV control packet or a remote identification (Remote ID) packet. The baseband integrated circuit (IC) is coupled to the processor for converting the UAV control packet or the Remote ID packet into a radio frequency (RF) signal. The antenna is coupled to the baseband integrated circuit for wirelessly transmitting the RF signal.

### BACKGROUND OF THE INVENTION

### 1. Field of the Invention

The invention is related to a wireless transmission module, in particularly, a wireless transmission module for an unmanned aerial vehicle.

### 2. Description of the Prior Art

Unmanned aerial vehicle (UAV), commonly known as unmanned aircraft or drone, refers to various remotely controlled aircraft that do not require a pilot to fly the aircraft (no pilot needed but can have passengers). UAVs are usually classified into military and civilian uses. As for unmanned fighters, they have performance similar to fighter jets and are low-cost. Drones are typically controlled using remote control, guidance, or autopilot. They can be used in scientific research, site exploration, military, and entertainment purposes.

Some drones have built-in or external cameras, and are often called “aerial drones”. The global market for drones has grown significantly in recent years and has become an important tool for commercial, government and consumer applications. It can support solutions in many fields and is widely used in construction, oil, natural gas, energy, agriculture, disaster relief and other fields.

As drones become more and more widely used, the Federal Aviation Administration (FAA) announced at the end of 2020 that all drones must remote identification have (Remote ID) for identification function starting in 2023. Remote ID allows the drone to broadcast relevant information, including: the remote pilot of the drone, the current location of the drone, etc., so that others can receive its position. However, if the drone is flying within an FAA-approved area, there is no need for a Remote ID.

When UAVs control and transmit image information, they typically use high-power wireless transmission modules to extend the maximum distance and improve the signal-to-noise ratio (SNR) of the transmitted data. This enables long-distance control and allows for instant image transmission. However, when broadcasting Remote ID, there is no requirement to use high-power wireless transmission modules.

### SUMMARY OF THE INVENTION

An embodiment of the present invention provides a wireless transmission module for an unmanned aerial vehicle (UAV). The wireless transmission module includes a processor, a baseband integrated circuit, and an antenna. The processor is used to process data to generate a UAV control packet or a remote identification (Remote ID) packet. The baseband integrated circuit (IC) is coupled to the processor, and used to convert the UAV control packet or the Remote ID packet into a radio frequency (RF) signal. The antenna is coupled to the baseband integrated circuit, and used to wirelessly transmit the RF signal.

Another embodiment of the present invention provides a wireless transmission method for an unmanned aerial vehicle (UAV). The wireless transmission method includes processing data using a processor to generate a UAV control packet or a remote identification (Remote ID) packet, converting the UAV control packet or the Remote ID packet into a radio frequency (RF) signal using a baseband integrated circuit (IC), and wirelessly transmitting the RF signal through an antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a wireless transmission module for an unmanned aerial vehicle (UAV) in an embodiment of the present invention.

FIG. 2 is a block diagram of a wireless transmission module for an unmanned aerial vehicle (UAV) in another embodiment of the present invention.

FIG. 3 is a flow chart of a method for the wireless transmission module in FIG. 2.

### DETAILED DESCRIPTION

In the era of widespread broadband communication, mobile devices have significantly enhanced convenience through wireless communication. These devices include mobile phones, tablets, laptops, and drones. Wireless technology also connects home televisions (TVs), wireless remote controls, home theater systems, audio systems, and monitoring/security setups, creating a seamless digital home experience. For wireless transmission, different frequency bands are used for short, medium, and long distances. These technologies rely on RF chip modules for operation, emphasizing the importance of their development and design. At the transmitter end, the radio frequency (RF) power amplifier (PA) plays a crucial role. Its primary function is to efficiently amplify the RF signal output power, ensuring it meets system requirements before transmission through the antenna. Achieving efficient and linear signal amplification for sufficient power is the central goal in power amplifier design.

In drone applications, the wireless transmission module plays a crucial role. This module connects to the drone's remote control, enabling features like remote control, high-definition live broadcasting, and long-distance data transmission. To extend the maximum wireless transmission distance, the power amplifier located near the antenna becomes essential. A high-power power amplifier efficiently boosts the radio frequency signal linearly and efficiently, allowing it to be transmitted through the antenna. This ensures timely reception by remote controls or smartphones at a distance. Users can then live broadcast footage captured by the drone or perform real-time remote control. However, when a drone broadcasts its remote identification (Remote ID), a high-power wireless transmission module is unnecessary. Instead, a lower-power power amplifier suffices for broadcasting. This allows other devices near the drone to receive information about its status, positioning, and other relevant details.

Considering that drones often need to broadcast Remote ID, using a high-power power amplifier for transmission would consume significant energy, thereby reducing the drone's battery life. To address this, the present invention introduces a wireless transmission module. This module employs a low-power power amplifier specifically for broadcasting Remote ID, while utilizing a high-power power amplifier for controlling and transmitting images.

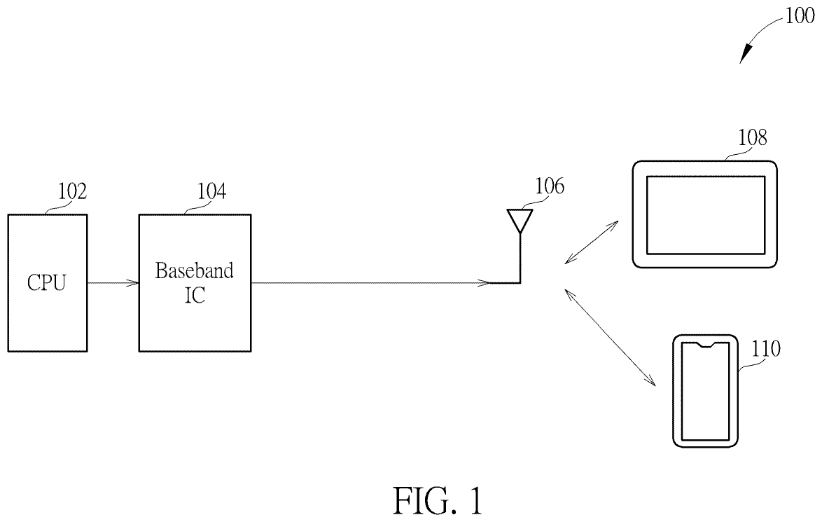

FIG. 1 is a block diagram of a wireless transmission module 100 for an unmanned aerial vehicle (UAV) in an embodiment of the present invention. The wireless transmission module 100 includes a central processing unit (CPU) 102, a baseband integrated circuit (IC) 104, and an antenna 106. The device connected to the wireless transmission module 100 may be a remote control 108 or a smart phone 110. The CPU 102 is used to process data to generate UAV control packets or Remote ID packets. The generated packets are converted into radio frequency (RF) signals through the baseband IC 104. In an embodiment, the RF signals can be Wi-Fi signals. Finally, the radio frequency signals are wirelessly transmitted to the remote control 108 or the smart phone 110 through the antenna 106 if the RF signals are converted from the UAV control packets. The RF signals are broadcasted if the RF signals are converted from Remote ID packets.

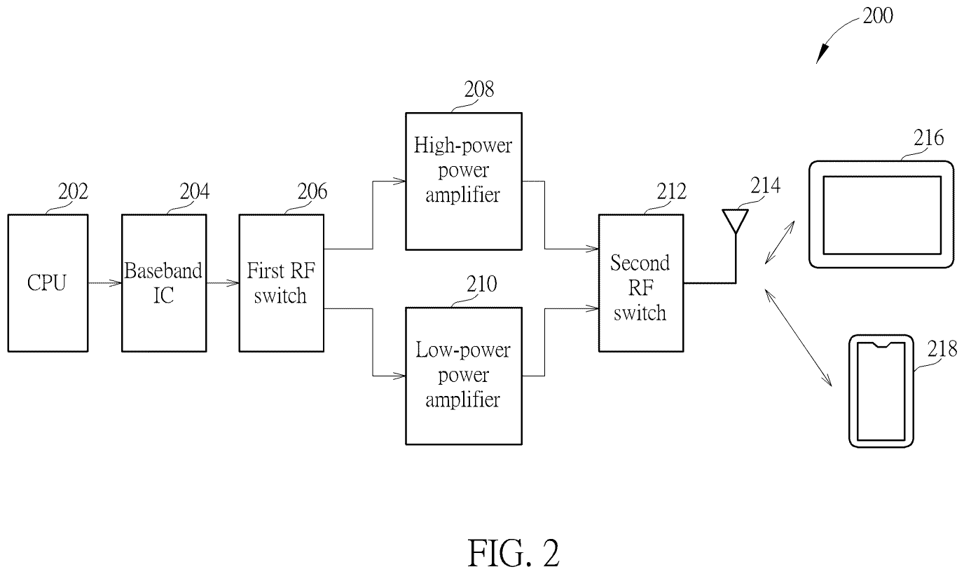

FIG. 2 is a block diagram of a wireless transmission module 200 for an unmanned aerial vehicle (UAV) in another embodiment of the present invention. The wireless transmission module 200 includes a CPU 202, a baseband IC 204, a first RF switch 206, a high-power power amplifier 208, a low-power power amplifier 210, a second RF switch 212 and an antenna 214. The device connected to the wireless transmission module 200 may be a remote control 216 or a smartphone 218.

The CPU 202 is used to process data to generate UAV control packets or Remote ID packets. If the CPU 202 generates the UAV control packets, the CPU 202 will adjust the control signal to switch the first RF switch 206 to connect with the high-power power amplifier 208, and switch the second RF switch 212 to connect with the high-power power amplifier 208. In this way, when generating the UAV control packets, the RF signals will pass through the high-power power amplifier 208 to serve the purpose of remote control and image transmission. When broadcasting the Remote ID packets, the CPU 202 will adjust the control signal to switch the first RF switch 206 and the second RF switch 212 to connect with the low-power power amplifier 210. In this way, when broadcasting the Remote ID packets, the RF signals will be amplified through the low-power power amplifier 210 to serve the purpose of power saving. In another embodiment, the RF signals converted from the Remote ID packets can be amplified by the high-power power amplifier 208.

The baseband IC 204 is coupled to the CPU 202 for converting UAV control packets or Remote ID packets into RF signals. In an embodiment, the RF signals can be Wi-Fi signals. In an embodiment, if the wireless transmission module 100 does not include any power amplifier as shown in FIG. 1, the RF signals can be directly transmitted through the antenna 106, but the transmission distance will be much shorter than that of a wireless transmission module with a power amplifier. In another embodiment, the RF signals are amplified by a power amplifier before they are transmitted to the antenna 214 to extend the communication distance, as shown in FIG. 2.

The first RF switch 206 is coupled to the baseband IC 204, the high-power power amplifier 208 and the low-power power amplifier 210, and is used to selectively transmit RF signals to the high-power power amplifier 208 to output high-power RF signals, or selectively transmit RF signals to the low-power power amplifier 210 to output low-power RF signals. Switching to the high-power power amplifier 208 or the low-power power amplifier 208 depends on control signal from the CPU 202.

The high-power power amplifier 208 is coupled to the first RF switch 206 and the second RF switch 212 for amplifying RF signals to generate high-power RF signals. The low-power power amplifier 210 is coupled to the first RF switch 206 and the second RF switch 212 for amplifying RF signal to generate low-power RF signals. Both power amplifiers are used to amplify RF signals to increase the wireless transmission distance and improve the signal-to-noise ratio (SNR). However, the high-power power amplifier 208 is suitable for amplifying RF signals converted from UAV control packets, and the low-power power amplifier 210 is suitable for amplifying RF signals converted from Remote ID packets.

The second RF switch 212 is coupled to the antenna 214, the high-power power amplifier 208 and the low-power power amplifier 210, and is used to selectively transmit high-power RF signals to the antenna 214, or selectively transmit low-power RF signals to the antenna 214. The antenna 214 is selectively connected to the high power amplifier 208 or the low power amplifier 210 according to the control signal from the CPU 202.

The antenna 214 is coupled to the second RF switch 212 for wirelessly transmitting amplified RF signals converted from UAV control packets to remote devices (such as smart phones and remote controls), or wirelessly broadcasting amplified RF signals converted from Remote ID packets to notify unconnected devices about the information of the UAV. The unconnected devices can be notified about the relevant information of the drone (positioning, type, etc.). In an embodiment, the second RF switch 212 and the antenna 214 can be replaced with antenna one and antenna two, which are coupled to the high-power power amplifier 208 and the low-power power amplifier 210 respectively. The antenna one and the antenna two can be antennas in the same frequency band or in different frequency bands. When antenna one and antenna two are in different frequency bands, RF signals converted from the UAV control packets and RF signals converted from the Remote ID packets need to be transmitted in different frequency bands.

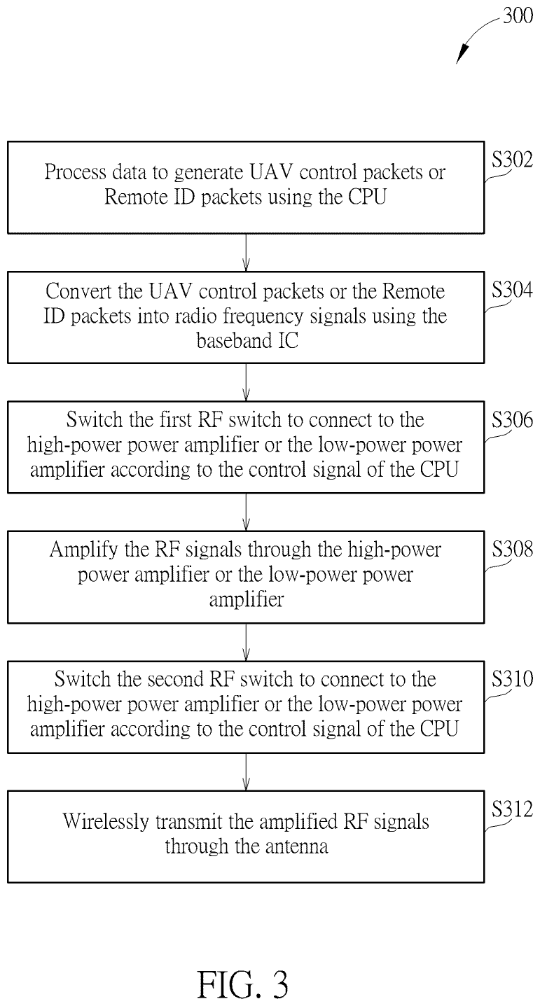

FIG. 3 is a flow chart of a method 300 for the wireless transmission module 200. This method 300 includes the following steps:
Step S302: process data to generate UAV control packets or Remote ID packets using the CPU 202;
Step S304: convert the UAV control packets or the Remote ID packets into radio frequency signals using the baseband IC 204;
Step S306: switch the first RF switch 206 to connect to the high-power power amplifier 208 or the low-power power amplifier 210 according to the control signal of the CPU 202;
Step S308: amplify the RF signals through the high-power power amplifier 208 or the low-power power amplifier 210;
Step S310: switch the second RF switch 212 to connect to the high-power power amplifier 208 or the low-power power amplifier 210 according to the control signal of the CPU 202;
Step S312: wirelessly transmit the amplified RF signals through the antenna 214;

In step S302, the CPU 202 processes data to generate UAV control packets or Remote ID packets, and the UAV control packets or Remote ID packets are converted into RF signals by the baseband IC 204 in step S304. In step S306, the first RF switch 206 is switched to connect to the high-power power amplifier 208 if the CPU 202 generates the UAV control packets or the low-power power amplifier 210 if the CPU 202 generates the Remote ID packets. In step S308, the RF signals are amplified through the high-power power amplifier 208 if the CPU 202 generates the UAV control packets or the low-power power amplifier 210 if the CPU 202 generates the Remote ID packets to generate high-power RF signals or low-power RF signals. In step S310, the second RF switch 212 transmits the high-power RF signals or the low-power RF signals to the antenna 214. In step S312, the antenna 214 wirelessly transmits the high-power RF signals and then communicates with the remote control 216 or the smart phone 218, or the antenna 214 broadcasts the low-power RF signals.

In summary, the wireless transmission module 200 of the present invention can use power amplifiers of different powers in different situations (wireless control, image transmission, Remote ID) to achieve long-distance transmission and power saving, and is mainly used for UAVs. The wireless transmission module, in an embodiment, can also be used in other wireless transmission applications, not limited to UAVs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless transmission module for an unmanned aerial vehicle (UAV), comprising:
a processor configured to process data to generate a UAV control packet or a broadcast remote identification (Remote ID) packet;
a baseband integrated circuit (IC) coupled to the processor, and configured to convert the UAV control packet or the broadcast Remote ID packet into a radio frequency (RF) signal; and
an antenna coupled to the baseband integrated circuit, and configured to wirelessly transmit the RF signal.

2. The wireless transmission module of claim 1, further comprising:
a power amplifier configured to amplify the RF signal to output an amplified RF signal, wherein the antenna is coupled to the power amplifier for wirelessly transmitting the amplified RF signal.

3. The wireless transmission module of claim 2, wherein the power amplifier is a high-power power amplifier, the amplified RF signal is a high-power RF signal, and the wireless transmission module further comprises:
a low-power power amplifier;
a first RF switch coupled to the baseband IC, the high-power power amplifier and the low-power power amplifier, and configured to selectively transmit the RF signal to the high-power power amplifier to enable the high-power power amplifier to output the high-power RF signal according to the RF signal, or selectively transmit the RF signal to the low-power power amplifier to enable the low-power power amplifier to output a low-power RF signal according to the RF signal; and
a second RF switch coupled to the high-power power amplifier, the low-power power amplifier and the antenna, and configured to selectively transmit the high-power RF signal to the antenna, or selectively transmit the low-power RF signal to the antenna;
wherein the antenna is configured to wirelessly transmit the high-power RF signal or the low-power RF signal.

4. The wireless transmission module of claim 3, wherein when the processor generates the UAV control packet, the first RF switch and the second RF switch are switched to connect to the high-power power amplifier.

5. The wireless transmission module of claim 3, wherein when the processor generates the broadcast remote ID packet, the first RF switch and the second RF switch are switched to connect to the high-power power amplifier or the low-power power amplifier.

6. A wireless transmission method for an unmanned aerial vehicle (UAV), comprising:
processing data using a processor to generate a UAV control packet or a remote identification (Remote ID) packet;
converting the UAV control packet or the Remote ID packet into a radio frequency (RF) signal using a baseband integrated circuit (IC); and
wirelessly transmitting the RF signal through an antenna.

7. The wireless transmission method of claim 6, further comprising:
amplifying the RF signal using a power amplifier to output an amplified RF signal, wherein wirelessly transmitting the RF signal through the antenna is wirelessly transmitting the amplified RF signal through the antenna.

8. The wireless transmission method of claim 7, wherein the power amplifier is a high-power power amplifier, the amplified RF signal is a high-power RF signal, and the method further comprises:
using a first RF switch to selectively transmit the RF signal to the high-power power amplifier to enable the high-power power amplifier to output the high-power RF signal according to the RF signal, or selectively transmit the RF signal to a low-power power amplifier to enable the low-power power amplifier to output a low-power RF signal according to the RF signal; and
using a second RF switch to selectively transmit the high-power RF signal to the antenna, or selectively transmit the low-power RF signal to the antenna;
wherein wirelessly transmitting the amplified RF signal through the antenna is wirelessly transmitting the high-power RF signal or low-power RF signal through the antenna.

9. The wireless transmission method of claim 8, further comprising:
switching the first RF switch and the second RF switch to the high-power power amplifier when the processor generates the UAV control packet.

10. The wireless transmission method of claim 8, further comprising:
switching the first RF switch and the second RF switch to the high-power power amplifier or the low-power power amplifier when the processor generates the broadcast remote ID packet.
